(19) United States
(12) Patent Application Publication
(10) Pub. No.: US 2023/0116287 A1
(43) Pub. Date: Apr. 13, 2023

(54) OPTICAL MODULE

(71) Applicant: HISENSE BROADBAND MULTIMEDIA TECHNOLOGIES CO., LTD., Qingdao (CN)

(72) Inventors: Long ZHENG, Qingdao (SD) (CN); Yuting DONG, JR., Qingdao (SD) (CN); Shicong HAO, Qingdao (SD) (CN); Sigeng YANG, Qingdao (SD) (CN); Qian SHAO, Qingdao (SD) (CN); Jihong HAN, Qingdao (SD) (CN); Jingqi SU, Qingdao (SD) (CN)

(73) Assignee: HISENSE BROADBAND MULTIMEDIA TECHNOLOGIES CO., LTD., Qingdao (CN)

(21) Appl. No.: 18/065,439

(22) Filed: Dec. 13, 2022

Related U.S. Application Data
(63) Continuation of application No. PCT/CN2022/082805, filed on Mar. 24, 2022.

(30) Foreign Application Priority Data
May 17, 2021 (CN) 202121054948.7
Jun. 17, 2021 (CN) 202121355472.0

(51) Int. Cl. G02B 6/42; G02B 6/12

(52) U.S. Cl. CPC G02B 6/4296; G02B 6/12; G02B 2006/12121; G02B 2006/12061

(57) ABSTRACT

An optical module includes a circuit board, a substrate, a laser assembly, and a silicon photonic chip. The silicon photonic chip is electrically connected to the circuit board through the substrate so as to ground the silicon photonic chip. The substrate includes a body, a first support step, and a second support step. The first support step is disposed at an end of the body. The second support step is disposed at another end of the body. The circuit board includes a first metal layer and a second metal layer. The first metal layer is disposed on a surface of the circuit board proximate to the first support step and is electrically connected to the first support step. The second metal layer is disposed on a surface of the circuit board proximate to the second support step and is electrically connected to the second support step.

### CROSS-REFERENCE TO RELATED APPLICATIONS

This application is a Continuation Application of International Application No. PCT/CN2022/082805 filed on Mar. 24, 2022, pending, which claims priority to Chinese Patent Application No. 202121054948.7, filed on May 17, 2021, and Chinese Patent Application No. 202121355472.0, filed on Jun. 17, 2021, which are incorporated herein by reference in their entireties.

### TECHNICAL FIELD

The present disclosure relates to the field of optical communication technologies, and in particular, to an optical module.

### BACKGROUND

Optical communication technologies are used in cloud computing, mobile Internet, video conferencing, and other new businesses and application models. In optical communication, an optical module is a tool for achieving interconversion between an optical signal and an electrical signal, and is a key component in an optical communication device. Using a silicon photonic chip to implement a photoelectric conversion function has become a mainstream solution adopted by high-speed optical modules.

### SUMMARY

In an aspect, an optical module is provided. The optical module includes a circuit board, a substrate, a laser assembly, and a silicon photonic chip. The circuit board includes a through hole disposed in a surface of the circuit board. The substrate is disposed in the through hole. The laser assembly is disposed on the substrate. The silicon photonic chip is disposed on the substrate and is optically connected to the laser assembly, and the silicon photonic chip is electrically connected to the circuit board through the substrate so as to ground the silicon photonic chip. The substrate includes a body, a first support step, and a second support step. The body is disposed in the through hole, and the laser assembly and the silicon photonic chip are disposed on the body. The first support step is disposed at an end of the body and is configured to support the circuit board. The second support step is disposed at another end of the body and is configured to support the circuit board. The circuit board includes a first metal layer and a second metal layer. The first metal layer is disposed on a surface of the circuit board proximate to the first support step and corresponds to a position of the first support step, and the first metal layer is electrically connected to the first support step. The second metal layer is disposed on a surface of the circuit board proximate to the second support step and corresponds to a position of the second support step, and the second metal layer is electrically connected to the second support step.

In another aspect, an optical module is provided. The optical module includes a circuit board, a substrate, a laser assembly and a silicon photonic chip. The circuit board includes a blind hole disposed in a surface thereof, and the blind hole includes a metal layer disposed on a bottom surface thereof. The substrate is disposed in the blind hole and is located on the metal layer, and the substrate is electrically connected to the circuit board through the metal layer. The laser assembly is disposed on the substrate. The silicon photonic chip is disposed on the substrate and is optically connected to the laser assembly, and the silicon photonic chip is electrically connected to the circuit board through the substrate so as to ground the silicon photonic chip.

### BRIEF DESCRIPTION OF THE DRAWINGS

In order to describe technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 is a diagram showing a connection relationship of an optical communication system, in accordance with some embodiments;

FIG. 2 is a structural diagram of an optical network terminal, in accordance with some embodiments;

FIG. 3 is a structural diagram of an optical module, in accordance with some embodiments;

FIG. 4 is an exploded view of an optical module, in accordance with some embodiments;

FIG. 5 is a structural diagram of an optical module with an upper shell and a lower shell removed, in accordance with some embodiments;

FIG. 6 is a structural diagram of an optical module with an upper shell, a lower shell, and a protective cover removed, in accordance with some embodiments;

FIG. 7 is a structural diagram of a circuit board in an optical module, in accordance with some embodiments;

FIG. 8 is structural diagram of a substrate in an optical module, in accordance with some embodiments;

FIG. 9 is a structural diagram of a substrate in an optical module from another angle, in accordance with some embodiments;

FIG. 10 is an assembly diagram of a substrate, a silicon photonic chip and a laser assembly in an optical module, in accordance with some embodiments;

FIG. 11 is an exploded view of a substrate, a silicon photonic chip and a laser assembly in an optical module, in accordance with some embodiments;

FIG. 12 is a structural diagram of a silicon photonic chip in an optical module, in accordance with some embodiments.

FIG. 13 is an assembly diagram of a substrate and a circuit board in an optical module, in accordance with some embodiments;

FIG. 14 is an assembly diagram of a substrate and a circuit board in an optical module from another angle, in accordance with some embodiments;

FIG. 15 is an exploded view of a substrate and a circuit board in an optical module, in accordance with some embodiments;

FIG. 16 is a cross-sectional view of a substrate and a circuit board that have been assembled in an optical module, in accordance with some embodiments;

FIG. 17 is a top view of a substrate in an optical module, in accordance with some embodiments;

FIG. 18 is a structural diagram of metal layers laid on an outer periphery of a through hole of a circuit board in an optical module, in accordance with some embodiments;

FIG. 19 is a diagram showing a relative positional relationship between support steps of a substrate and metal layers laid on an outer periphery of a through hole in an optical module, in accordance with some embodiments;

FIG. 20 is a structural diagram of another circuit board in an optical module, in accordance with some embodiments;

FIG. 21 is an assembly diagram of another substrate and a circuit board in an optical module, in accordance with some embodiments;

FIG. 22 is a top view showing a relative relationship between a signal pad and other structures in an optical module, in accordance with some embodiments;

FIG. 23 is an enlarged view showing a relative relationship between a signal pad and other structures in an optical module, in accordance with some embodiments;

FIG. 24 is a structural diagram of a laser assembly in an optical module, in accordance with some embodiments;

FIG. 25 is a structural diagram of a circuit board, a silicon photonic chip and a laser assembly in an optical module, in accordance with some embodiments;

FIG. 26 is a diagram showing a relative positional relationship between a laser upper cover and a circuit board in an optical module, in accordance with some embodiments;

FIG. 27 is a structural diagram of a laser upper cover in an optical module, in accordance with some embodiments;

FIG. 28 is a structural diagram of a laser upper cover in an optical module from another angle, in accordance with some embodiments; and

FIG. 29 is a connection diagram of a silicon photonic chip and a circuit board in an optical module, in accordance with some embodiments.

### DETAILED DESCRIPTION

Technical solutions in some embodiments of the present disclosure will be described clearly and completely below with reference to the accompanying drawings. However, the described embodiments are merely some but not all embodiments of the present disclosure. All other embodiments obtained on a basis of the embodiments of the present disclosure by a person of ordinary skill in the art shall be included in the protection scope of the present disclosure.

Unless the context requires otherwise, throughout the description and the claims, the term “comprise” and other forms thereof such as the third-person singular form “comprises” and the present participle form “comprising” are construed in an open and inclusive sense, i.e., “including, but not limited to.” In the description, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Therefore, the features defined with “first” and “second” may explicitly or implicitly include one or more of these features. In the description of the embodiments of the present disclosure, the term “a/the plurality of” means two or more unless otherwise specified.

In the description of some embodiments, the terms “coupled,” “connected,” and derivatives thereof may be used. The term “connection” should be understood in a broad sense. For example, it may be a fixed connection, a detachable connection, or an integral connection; and it may be a direct connection, or may be an indirect connection through an intermediate medium. The term “coupled” or “communicatively coupled,” however, may also mean that two or more elements are not in direct contact with each other, but still cooperate or interact with each other. The embodiments disclosed herein are not necessarily limited to the content herein.

The phrase “at least one of A, B, and C” has the same meaning as the phrase “at least one of A, B, or C,” and both include the following combinations of A, B, and C: only A, only B, only C, a combination of A and B, a combination of A and C, a combination of B and C, and a combination of A, B and C.

The phrase “A and/or B” includes the following three combinations: only A, only B, and a combination of A and B.

The usage of the phrase “applicable to” or “configured to” herein indicates an open and inclusive expression, which does not exclude devices that are applicable to or configured to perform additional tasks or steps.

The terms “about,” “substantially,” and “approximately” as used herein includes a stated value and an average value within an acceptable range of deviation of a particular value. The acceptable range of deviation is determined by a person of ordinary skill in the art in consideration of the measurement in question and errors associated with the measurement of a particular quantity (i.e., limitations of the measurement system).

Exemplary embodiments are described herein with reference to sectional views and/or plan views as idealized exemplary drawings. Therefore, variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. Thus, the regions shown in the accompanying drawings are schematic in nature, and their shapes are not intended to show actual shapes of regions in a device, and are not intended to limit the scope of the exemplary embodiments.

In an optical communication system, an optical signal is used to carry information to be transmitted, and the optical signal carrying the information is transmitted to an information processing device such as a computer through an information transmission device such as an optical fiber or an optical waveguide, so as to achieve transmission of the information. Due to the passive transmission characteristic of light when being transmitted through the optical fiber or the optical waveguide, low-cost and low-loss information transmission may be achieved. In addition, since a signal transmitted by the information transmission device such as the optical fiber or the optical waveguide is an optical signal, and a signal that can be recognized and processed by the information processing device such as the computer is an electrical signal, in order to establish information connection between the information transmission device such as the optical fiber or the optical waveguide and the information processing device such as the computer, interconversion between the electrical signal and the optical signal needs to be achieved.

In the field of optical fiber communication technology, an optical module may achieve the interconversion between the optical signal and the electrical signal. The optical module includes an optical port and an electrical port. The optical module achieves optical communication with the information transmission device such as the optical fiber or the optical waveguide through the optical port, and the optical module achieves electrical connection with an optical network terminal (e.g., an optical modem) through the electrical port. The electrical connection is mainly used for implementing power supply, 120 signal transmission, data information transmission, and grounding. The optical network terminal transmits the electrical signal to the information processing device such as the computer through a network cable or wireless fidelity (Wi-Fi).

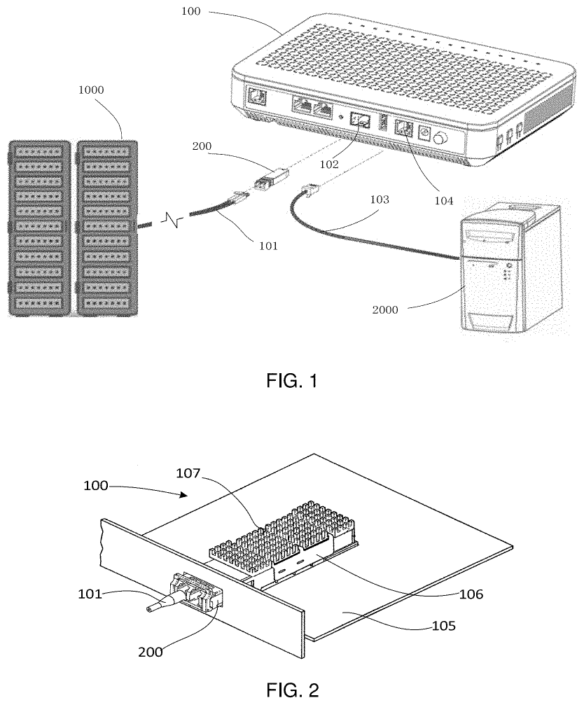

FIG. 1 is a diagram showing a connection relationship of an optical communication system, in accordance with some embodiments. As shown in FIG. 1, the optical communication system includes a remote server 1000, a local information processing device 2000, an optical network terminal 100, an optical module 200, an optical fiber 101, and a network cable 103.

An end of the optical fiber 101 is connected to the remote server 1000, and another end thereof is connected to the optical network terminal 100 through the optical module 200. The optical fiber itself supports long-distance signal transmission, for example, signal transmission over several kilometers (6 kilometers to 8 kilometers). Based on this, if repeaters are used, theoretically, it may be possible to achieve infinite-distance transmission. Therefore, in a typical optical communication system, a distance between the remote server 1000 and the optical network terminal 100 may typically reach several kilometers, dozens of kilometers, or hundreds of kilometers.

An end of the network cable 103 is connected to the local information processing device 2000, and another end thereof is connected to the optical network terminal 100. The local information processing device 2000 includes one or more of a router, a switch, a computer, a mobile phone, a tablet computer, or a television.

A physical distance between the remote server 1000 and the optical network terminal 100 is greater than a physical distance between the local information processing device 2000 and the optical network terminal 100. A connection between the local information processing device 2000 and the remote server 1000 is achieved by the optical fiber 101 and the network cable 103, and a connection between the optical fiber 101 and the network cable 103 is achieved by the optical module 200 and the optical network terminal 100.

The optical module 200 includes an optical port and an electrical port. The optical port is configured to connect to the optical fiber 101, so that a bidirectional optical signal connection is established between the optical module 200 and the optical fiber 101. The electrical port is configured to connect to the optical network terminal 100, so that a bidirectional electrical signal connection is established between the optical module 200 and the optical network terminal 100. The optical module 200 may achieve interconversion between the optical signal and the electrical signal, so that an information connection is established between the optical fiber 101 and the optical network terminal 100. For example, an optical signal from the optical fiber 101 is converted into an electrical signal by the optical module 200, and then the electrical signal is input to the optical network terminal 100; and an electrical signal from the optical network terminal 100 is converted into an optical signal by the optical module 200, and then the optical signal is input to the optical fiber 101. Since the optical module 200 is a tool for achieving interconversion between the optical signal and the electrical signal and doesn't have a data processing function, the information does not change in the above photoelectric conversion process.

The optical network terminal 100 includes a housing in a substantially cuboid shape, and an optical module interface 102 and a network cable interface 104 that are disposed on the housing. The optical module interface 102 is configured to connect to the optical module 200, so that a bidirectional electrical signal connection is established between the optical network terminal 100 and the optical module 200. The network cable interface 104 is configured to connect to the network cable 103, so that a bidirectional electrical signal connection is established between the optical network terminal 100 and the network cable 103. A connection between the optical module 200 and the network cable 103 is established through the optical network terminal 100. For example, the optical network terminal 100 transmits an electrical signal from the optical module 200 to the network cable 103, and transmits an electrical signal from the network cable 103 to the optical module 200. Therefore, the optical network terminal 100, as a master monitor of the optical module 200, may monitor operation of the optical module 200. In addition to the optical network terminal 100, the master monitor of the optical module 200 may further include an optical line terminal (OLT).

A bidirectional signal transmission channel is established between the remote server 1000 and the local information processing device 2000 through the optical fiber 101, the optical module 200, the optical network terminal 100, and the network cable 103.

FIG. 2 is a structural diagram of an optical network terminal, in accordance with some embodiments. In order to clearly show a connection relationship between the optical module 200 and the optical network terminal 100, FIG. 2 only shows a structure of the optical network terminal 100 that is related to the optical module 200. As shown in FIG. 2, the optical network terminal 100 further includes a circuit board 105 disposed in the housing, a cage 106 disposed on a surface of the circuit board 105, a heat sink 107 disposed on the cage 106, and an electrical connector disposed inside the cage 106. The electrical connector is configured to connect to the electrical port of the optical module 200. The heat sink 107 has protruding portions such as fins for increasing a heat dissipation area.

The optical module 200 is inserted into the cage 106 of the optical network terminal 100, and the optical module 200 is fixed by the cage 106. Heat generated by the optical module 200 is conducted to the cage 106 and is then dissipated through the heat sink 107. After the optical module 200 is inserted into the cage 106, the electrical port of the optical module 200 is connected to the electrical connector inside the cage 106, so that a bidirectional electrical signal connection is established between the optical module 200 and the optical network terminal 100. In addition, the optical port of the optical module 200 is connected to the optical fiber 101, so that a bidirectional optical signal connection is established between the optical module 200 and the optical fiber 101.

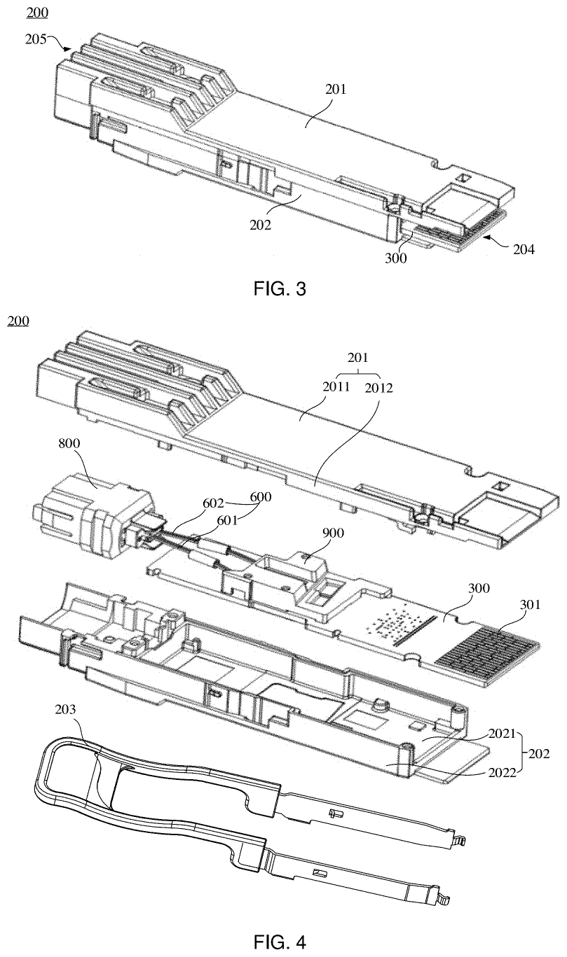

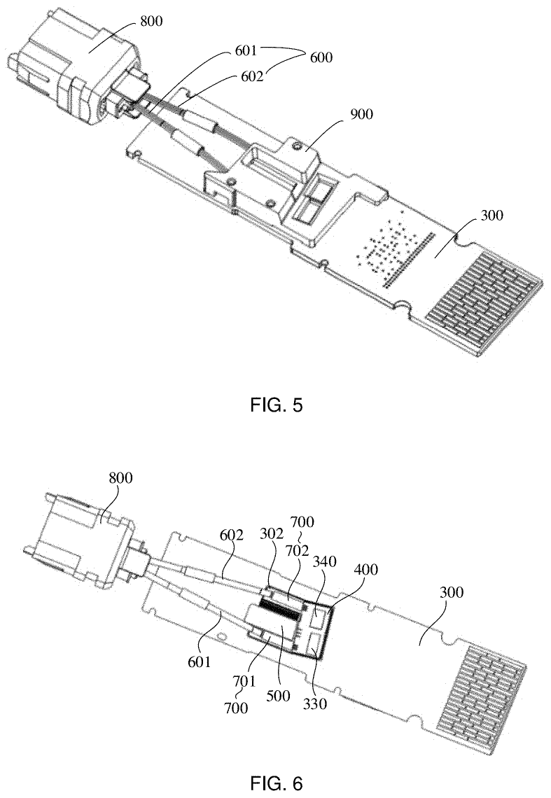

FIG. 3 is a structural diagram of an optical module, in accordance with some embodiments. FIG. 4 is an exploded view of an optical module, in accordance with some embodiments. FIG. 5 is a structural diagram of an optical module with an upper shell and a lower shell removed, in accordance with some embodiments. FIG. 6 is a structural diagram of an optical module with an upper shell, a lower shell, and a protective cover removed, in accordance with some embodiments. As shown in FIGS. 3 to 6, the optical module 200 includes a shell, and a circuit board 300, a silicon photonic chip 400, and a laser assembly 500 that are disposed inside the shell.

The shell includes an upper shell 201 and a lower shell 202. The upper shell 201 covers on the lower shell 202 to form the shell with two openings. An outer contour of the shell is generally in a cuboid shape.

In some embodiments of the present disclosure, the lower shell 202 includes a bottom plate 2021 and two lower side plates 2022 that are located on two sides of the bottom plate 2021 and disposed perpendicular to the bottom plate 2021. The upper shell 201 includes a cover plate 2011, and the cover plate 2011 covers the two lower side plates 2022 of the lower shell 202 to form the shell.

In some embodiments, the lower shell 202 includes a bottom plate 2021 and two lower side plates 2022 that are located on two sides of the bottom plate 2021 and disposed perpendicular to the bottom plate 2021; the upper shell 201 includes a cover plate 2011 and two upper side plates 2012 that are located on two sides of the cover plate 2011 and disposed perpendicular to the cover plate 2011. The two upper side plates 2012 are combined with the two lower side plates 2022, respectively, so as to achieve a result that the upper shell 201 covers the lower shell 202.

A direction in which a connection line between the two openings 204 and 205 extends may be the same as a longitudinal direction of the optical module 200, or may not be the same as the longitudinal direction of the optical module 200. For example, the opening 204 is located at an end (a right end in FIG. 3) of the optical module 200, and the opening 205 is also located at an end (a left end in FIG. 3) of the optical module 200. Alternatively, the opening 204 is located at an end of the optical module 200, while the opening 205 is located at a side of the optical module 200. The opening 204 is the electrical port, and a connecting finger 301 of the circuit board 300 extends out from the electrical port 204, and is inserted into the master monitor (e.g., the optical network terminal 100). The opening 205 is the optical port, and is configured to connect to an external optical fiber 101, so that the external optical fiber 101 is connected to the silicon photonic chip 400 in the optical module 200.

With an assembly manner of combining the upper shell 201 with the lower shell 202, it may be easier to install the circuit board 300, the silicon photonic chip 400, and the laser assembly 500 into the shell, and the upper shell 201 and the lower shell 202 may provide sealing and protection for these components. In addition, during the assembly of the circuit board 30, the silicon photonic chip 400, and the laser assembly 500, it may be easier to arrange the positioning elements, heat dissipation elements, and electromagnetic shielding elements of these components, which facilitates the implementation of automated production.

In some embodiments, the upper shell 201 and the lower shell 202 are generally made of a metallic material, which helps achieve electromagnetic shielding and heat dissipation.

In some embodiments, the optical module 200 further includes an unlocking component 203 located outside of the shell. The unlocking component 203 is configured to implement a fixed connection between the optical module 200 and the master monitor, or to release the fixed connection between the optical module 200 and the master monitor.

For example, the unlocking component 203 is located on outer walls of the two lower side plates 2022 of the lower shell 202, and has an engagement element that is matched with the cage of the master monitor (e.g., the cage 106 of the optical network terminal 100). When the optical module 200 is inserted into the cage of the master monitor, the optical module 200 is fixed in the cage of the master monitor by the engagement element of the unlocking component 203. When the unlocking component 203 is pulled, the engagement element of the unlocking component 203 moves along with the unlocking component, and then a connection relationship between the engagement element and the master monitor is changed to release the engagement between the optical module 200 and the master monitor, so that the optical module 200 is pulled out of the cage of the master monitor.

The circuit board 300 includes circuit traces, electronic elements and chips. Through the circuit traces, the electronic elements and the chips are connected together according to circuit design, so as to implement power supply, electrical signal transmission, and grounding functions. The electronic elements may include, for example, a capacitor, a resistor, a triode, and a metal-oxide-semiconductor field-effect transistor (MOSFET). The chips may include, for example, a microcontroller unit (MCU), a limiting amplifier, a clock and data recovery (CDR) chip, a power management chip, or a digital signal processing (DSP) chip.

The circuit board 300 is generally a rigid circuit board. Since it is made of a relatively hard material, the rigid circuit board may also have a support function. For example, the rigid circuit board may stably support the electronic elements and the chips. The rigid circuit board may also be inserted into the electrical connector in the cage 106 of the master monitor.

The circuit board 300 further includes a connecting finger 301 formed on an end surface thereof, and the connecting finger 301 is composed of a plurality of independent pins. The circuit board 300 is inserted into the cage 106, and is conductively connected to the electrical connector in the cage 106 through the connecting finger 301. The connecting finger 301 may be disposed on only one surface (e.g., an upper surface shown in FIG. 4) of the circuit board 300, or may be disposed on both upper and lower surfaces of the circuit board 300 to adapt to an occasion where a large number of pins are needed. The connecting finger 301 is configured to establish an electrical connection with the master monitor to implement power supply, grounding, 120 signal transmission, data signal transmission, and other functions.

Of course, flexible circuit boards are also used in some optical modules. A flexible circuit board is generally used in conjunction with a rigid circuit board to serve as a supplement for the rigid circuit board.

It will be understood that the silicon photonic chip 400 and the laser assembly 500 need to be electrically connected to the circuit board 300. For example, the silicon photonic chip 400 and the laser assembly 500 are electrically connected to the circuit board 300 through a wire bonding process, and connection wires between the circuit board 300 and both of the silicon photonic chip 400 and the laser assembly 500 are gold wires.

During shell encapsulation of the optical module 200 or during use of the optical module 200, since the gold wires are very thin and fragile (due to a small diameter) and the distance between the wires is very small (due to high-density wiring), the gold wires are very prone to deformation, damage, or collapse, which may lead to short circuits, open circuits, and other problems.

Based on this, in some embodiments, as shown in FIG. 5, the optical module 200 further includes a protective cover 900. The protective cover 900 is configured to protect the electrical connection wires between the circuit board 300 and both of the silicon photonic chip 400 and the laser assembly 500. For example, the protective cover 900 covers the circuit board 300 and forms a sealed space with the circuit board 300, and the silicon photonic chip 400, the wiring region of the silicon photonic chip 400, the laser assembly 500, and the wiring region of the laser assembly 500 are all encapsulated in the sealed space.

It will be noted that the description “encapsulated in the sealed space” means that, in the sealed space formed by the protective cover 900 and the circuit board 300, the silicon photonic chip 400, the wiring region of the silicon photonic chip 400, the laser assembly 500, and the wiring region of the laser assembly 500 are in clearance fit with the protective cover 900.

The silicon photonic chip 400 itself has no light source, and the laser assembly 500 is used as an external light source for the silicon photonic chip 400. A laser box may be adopted as the laser assembly 500; a laser chip is encapsulated in the laser box; the laser chip emits light, and the laser assembly 500 is used to provide a laser beam to the silicon photonic chip 400.

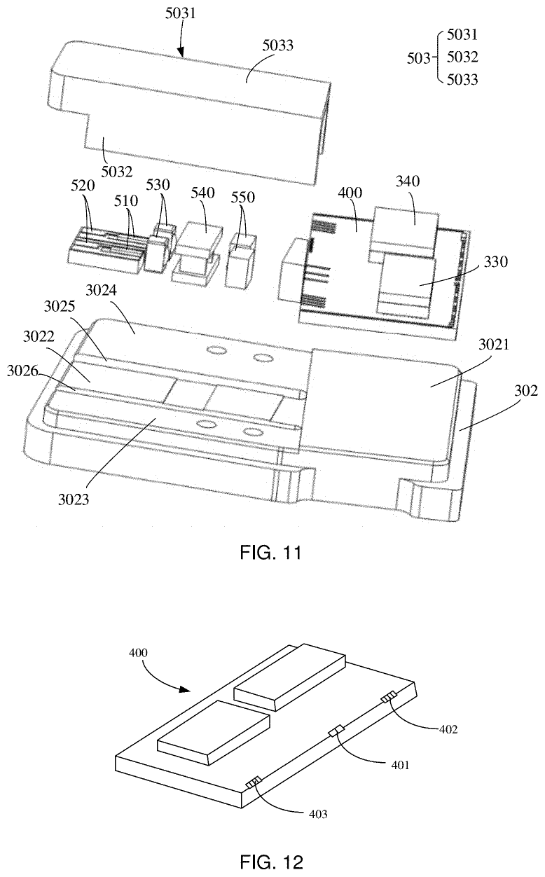

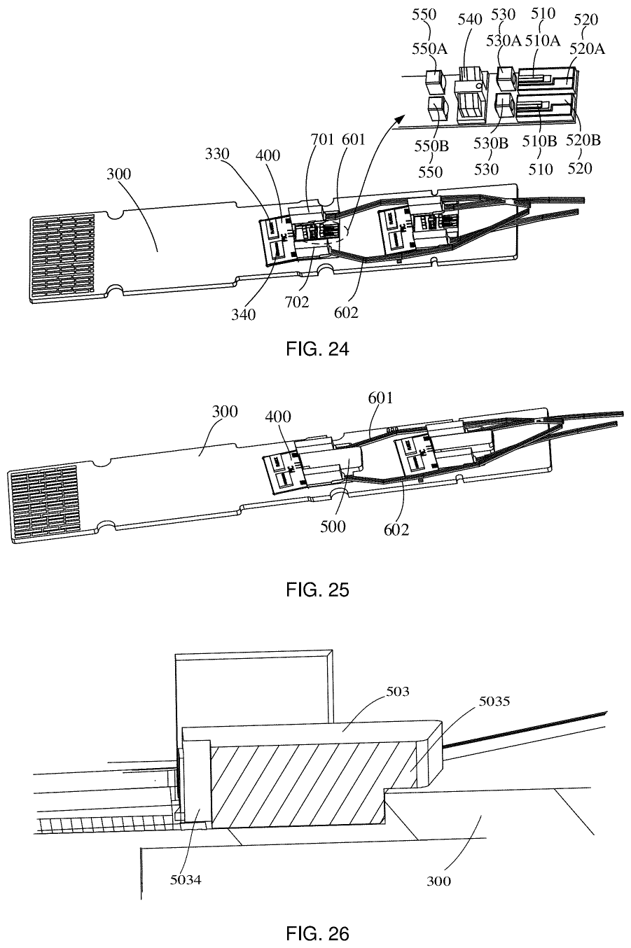

FIG. 11 is an exploded view of a substrate, a silicon photonic chip and a laser assembly in an optical module, in accordance with some embodiments, and FIG. 24 is a structural diagram of a laser assembly in an optical module, in accordance with some embodiments. As shown in FIGS. 11 and 24, the laser assembly 500 includes a laser upper cover 503, and at least one laser chip 510, at least one spacer 520, at least one collimating lens 530, at least one isolator 540, and at least one converging lens 550 that are covered by the laser upper cover 503.

The numbers of the laser chips 510, the spacers 520, the collimating lenses 530, the isolators 540, and the converging lenses 550 are not limited in the embodiments of the present disclosure, each of which may be one or more. For example, FIGS. 11 and 24 show an example where there are two laser chips 510, two spacers 520, two collimating lenses 530, one isolator 540, and two converging lenses 550.

The two laser chips 510 are a first laser chip 510A and a second laser chip 5108. The two spacers 520 are a first spacer 520A and a second spacer 520B. The two collimating lenses 530 are a first collimating lens 530A and a second collimating lens 530B. The two converging lenses 550 are a first converging lens 550A and a second converging lens 550B.

The first laser chip 510A is disposed on a surface of the first spacer 520A, and the first collimating lens 530A, the isolator 540 and the first converging lens 550A are sequentially disposed in a laser exit direction of the first laser chip 510A. The second laser chip 5108 is disposed on a surface of the second spacer 520B, and the second collimating lens 530B, the isolator 540 and the second converging lens 550B are sequentially disposed in a laser exit direction of the second laser chip 5108. Two laser beams emitted by the two laser chips 510 share one isolator 540.

The laser beam emitted by the first laser chip 510A is converted into a collimated laser beam by the first collimating lens 530A, and the collimated laser beam may maintain small optical power attenuation during transmission of the beam over a long distance. The collimated laser beam enters the first converging lens 550A through the isolator 540, and is converted into a converged laser beam by the first converging lens 550A, and then the converged laser beam is coupled into the silicon photonic chip 400. Similarly, the laser beam emitted by the second laser chip 5108 is converted into a collimated laser beam by the second collimating lens 530B; the collimated laser beam enters the second converging lens 550B through the isolator 540, and is converted into a converged laser beam by the second converging lens 550B, and then the converged laser beam is coupled into the silicon photonic chip 400.

The silicon photonic chip 400 is optically connected to the laser assembly 500. The laser beam emitted by the laser assembly 500 enters the silicon photonic chip 400, and the silicon photonic chip 400 receives the laser beam from the laser assembly 500. In some embodiments, the laser assembly 500 provides a laser beam with a single wavelength, stable power, and no information to the silicon photonic chip 400, and the silicon photonic chip 400 modulates the laser beams, so as to load the data to be transmitted into the laser beam to form an optical signal. In addition, the silicon photonic chip 400 also receives an optical signal from an outside of the optical module 200, and converts the optical signal into a current signal to extract data from the optical signal. That is, both the modulation of the laser beam emitted by the optical module 200 and the demodulation of the optical signal received by the optical module 200 are completed by the silicon photonic chip 400.

In some embodiments, as shown in FIG. 6, the optical module 200 further includes a transimpedance amplifier 330 and a laser driver chip 340 that are disposed on the silicon photonic chip 400. The transimpedance amplifier 330 is configured to convert the current signal output by the silicon photonic chip 400 into a voltage signal, and the laser driver chip 340 is configured to provide a modulation signal to the silicon photonic chip 400.

A process in which the optical module 200 implements the interconversion between the optical signal and the electrical signal is described as follows. The electrical signal from the master monitor is transmitted to a digital signal processing chip through the connecting finger 301 of the circuit board 300, and is then transmitted to the laser driver chip 340 after being processed by the digital signal processing chip; the silicon photonic chip 400 receives a laser beam carrying no information that is output by the laser assembly 500, and modulates the received laser beam according to the modulation signal output by the laser driver chip 340 to form an optical signal; and then the optical signal is sent to the outside of the optical module 200, thereby realizing the conversion from the electrical signal into the optical signal. The optical signal from the outside of the optical module 200 is converted into a current signal through the silicon photonic chip 400, the current signal is converted into a differential voltage signal by the transimpedance amplifier 330, and the differential voltage signal is output to the master monitor through the connecting finger 301 of the circuit board 300 after being processed by the digital signal processing chip, thereby realizing the conversion of the optical signal into the electrical signal.

As shown in FIGS. 5 and 6, the optical module 200 further includes an optical fiber interface 800 and two internal optical fiber ribbons 600. The two internal optical fiber ribbons 600 are a first internal optical fiber ribbon 601 and a second internal optical fiber ribbon 602, and the first internal optical fiber ribbon 601 and the second internal optical fiber ribbon 602 are thin flat ribbons formed by a plurality of internal optical fibers arranged in parallel and cured by ultraviolet light.

In some embodiments of the present disclosure, the first internal optical fiber ribbon 601 is an emitting optical fiber ribbon, and the second internal optical fiber ribbon 602 is a receiving optical fiber ribbon. An end of the first internal optical fiber ribbon 601 is connected to the silicon photonic chip 400, and another end thereof is connected to the optical fiber interface 800. An end of the second internal optical fiber ribbon 602 is connected to the silicon photonic chip 400, and another end thereof is connected to the optical fiber interface 800. The optical fiber interface 800 is configured to be connected to the external optical fiber 101. It will be seen that the silicon photonic chip 400 is optically connected to the external optical fiber 101 through the first internal optical fiber ribbon 601, the second internal optical fiber ribbon 602, and the optical fiber interface 800.

To ensure the stability of relative positions between the silicon photonic chip 400 and both of the first internal optical fiber ribbon 601 and the second internal optical fiber ribbon 602, and thus ensure a coupling efficiency of the silicon photonic chip 400 and both of the first internal optical fiber ribbon 601 and the second internal optical fiber ribbon 602, in some embodiments, it is arranged that the optical module 200 further includes two optical fiber ribbon connectors 700, and the two optical fiber ribbon connectors 700 are a first optical fiber ribbon connector 701 and a second optical fiber ribbon connector 702. The first optical fiber ribbon connector 701 is configured to clamp the end of the first internal optical fiber ribbon 601 that is connected to the silicon photonic chip 400, and the second optical fiber ribbon connector 702 is configured to clamp the end of the second internal optical fiber ribbon 602 that is connected to the silicon photonic chip 400.

The laser assembly 500 transmits the laser beam carrying no information to the silicon photonic chip 400, the silicon photonic chip 400 modulates the laser beam carrying no information to form an optical signal, and the optical signal is transmitted to the external optical fiber 101 through the first internal optical fiber ribbon 601 and the optical fiber interface 800. The optical signal from the external optical fiber 101 is transmitted to the silicon photonic chip 400 through the optical fiber interface 800 and the second internal optical fiber ribbon 602. In this way, it is realized that the optical module 200 outputs the optical signal to the external optical fiber 101 or receives the optical signal from the external optical fiber 101.

FIG. 12 is a structural diagram of a silicon photonic chip in an optical module, in accordance with some embodiments. In some embodiments of the present disclosure, in order to make it easier for the silicon photonic chip to receive and transmit optical signals, as shown in FIG. 12, it is arranged that the silicon photonic chip 400 includes a first optical waveguide end surface 401, a second optical waveguide end surface 402, and a third optical waveguide end surface 403 that are disposed on a laser incident surface thereof, and each optical waveguide end surface has at least one optical channel. For example, as shown in FIG. 12, the first optical waveguide end surface 401 has two optical channels, the second optical waveguide end surface 402 has four optical channels, and the third optical waveguide end surface 403 has four optical channels.

It will be noted that, a laser exit surface of the laser assembly 500 is the surface of the laser assembly 500 proximate to the silicon photonic chip 400, and the laser incident surface of the silicon photonic chip 400 is a surface of the silicon photonic chip 400 proximate to the laser assembly 500.

The first optical waveguide end surface 401 is optically connected to the laser assembly 500, and is configured to receive the laser beam carrying no information emitted by the laser assembly 500. The second optical waveguide end surface 402 is connected to an end of the first internal optical fiber ribbon 601, and is configured to transmit an optical signal obtained after modulation by the silicon photonic chip 400 to the outside of the optical module 200. The third optical waveguide end surface 403 is coupled to an end of the second internal optical fiber ribbon 602, and is configured to receive the optical signal from the outside of the optical module 200.

The laser assembly 500 provides a laser beam carrying no information to the silicon photonic chip 400, and the laser beam carrying no information enters the silicon photonic chip 400 through the first optical waveguide end surface 401. The silicon photonic chip 400 modulates the received laser beam carrying no information to form an optical signal, and the optical signal is transmitted to the first internal optical fiber ribbon 601 through the second optical waveguide end surface 402, and is then transmitted to the outside of the optical module 200 through the first internal optical fiber ribbon 601 and the optical fiber interface 800. The optical signal from the outside of the optical module 200 is transmitted to the third optical waveguide end surface 403 through the optical fiber interface 800 and the second internal optical fiber ribbon 602, and is then transmitted into the silicon photonic chip 400 through the third optical waveguide end surface 403. In this way, it is realized that the silicon photonic chip 400 outputs the optical signal to the outside of the optical module 200 and receives the optical signal from the outside of the optical module 200.

In order to realize the above modulation and demodulation processes of the optical signal, the circuit board 300, the silicon photonic chip 400, and the laser assembly 500 need to be assembled according to their predetermined positions, so as to form a predetermined optical propagation path.

Since the optical path is very sensitive to a positional relationship between the silicon photonic chip 400 and the laser assembly 500, materials with different thermal expansion coefficients will deform to different degrees, which is not conducive to implementing a predetermined optical path. In some embodiments of the present disclosure, the optical module 200 further includes a substrate 302. The silicon photonic chip 400 and the laser assembly 500 are disposed on the same substrate 302, and the substrate 302 is a plate-shaped structure made of a same material. The substrate 302 made of the same material is deformed identically when heated; therefore, the deformation of the substrate 302 has a same impact on the silicon photonic chip 400 and the laser assembly 500, which may avoid a change in the relative position between the silicon photonic chip 400 and the laser assembly 500.

A material of the substrate 302 is not limited in some embodiments of the present disclosure. For example, the material of the substrate 302 includes tungsten copper or aluminum nitride ceramic. For example, the thermal expansion coefficient of the material of the substrate 302 is close to that of the silicon photonic chip 400 and/or the laser assembly 500. For example, a main material of the silicon photonic chip 400 is silicon, the laser assembly 500 is made of KOVAR® alloy, and the substrate 302 is made of silicon or glass. KOVAR® alloy, also known as iron-nickel-cobalt alloy or iron-nickel-cobalt glass sealing alloy, generally contains 29% of nickel and 18% of cobalt, and the rest is iron. Due to the addition of cobalt, the thermal expansion coefficient of KOVAR® alloy is reduced and becomes close to that of glass, which makes KOVAR® alloy suitable for sealing to glass.

It will be seen from the above that the silicon photonic chip 400 and the laser assembly 500 are generally disposed on a same side of the circuit board 300. In this case, the positional relationship between the substrate 302 and the circuit board 300 varies.

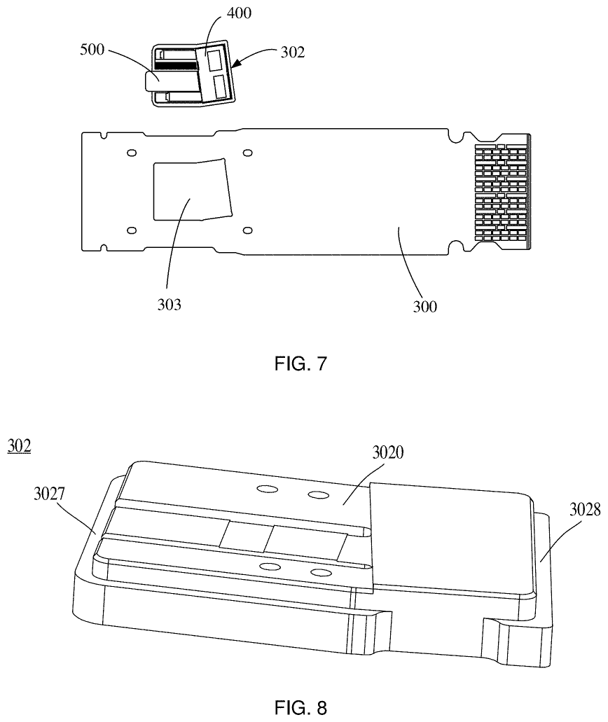

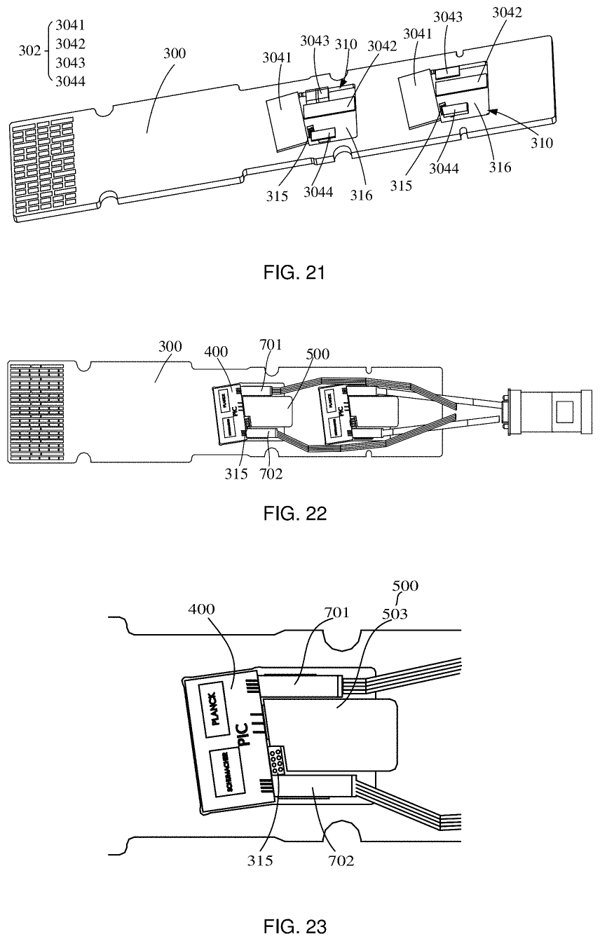

FIG. 7 is a structural diagram of a circuit board in an optical module, in accordance with some embodiments. FIG. 20 is a structural diagram of another circuit board in an optical module, in accordance with some embodiments. FIG. 21 is an assembly diagram of another substrate and a circuit board in an optical module, in accordance with some embodiments. FIG. 22 is a top view showing a relative relationship between a signal pad and other structures in an optical module, in accordance with some embodiments. As shown in FIGS. 7 and 20 to 22, the circuit board 300 includes a groove disposed on a surface thereof, and the groove may be a through hole 303 penetrating upper and lower surfaces of the circuit board 300 or a blind hole 310 not penetrating the upper and lower surfaces of the circuit board 300. The substrate 302 is disposed in the groove, and the silicon photonic chip 400 and the laser assembly 500 are disposed on a surface of the substrate 302. In this way, it may not only be possible to avoid a change in the relative position between the silicon photonic chip 400 and the laser assembly 500, but it may also be possible to facilitate the electrical connection between the circuit board 300 and both of the silicon photonic chip 400 and the laser assembly 500. In addition, the silicon photonic chip 400 and the laser assembly 500 may dissipate heat to the substrate 302; therefore, the substrate 302 may have both supporting and heat dissipating effects.

The number of the substrates 302 and the number of the grooves are not limited in some embodiments of the present disclosure, each of which may be one or more. For example, FIG. 7 shows one substrate 302 and one groove. For example, FIG. 21 shows two substrates 302 and two grooves, with each substrate 302 disposed in a corresponding groove. A description will be given below by taking an example where only one substrate 302 and only one groove are provided.

It will be noted that, in a case where the components are applied to an optical module with a high transmission rate, such as 800 Gb/s, the number of each component of the optical module 200, for example, the silicon photonic chip 400, the laser assembly 500, the substrate 302, and the groove, is two; in a case where the components are applied to a 400 Gb/s optical module, the number of each component of the optical module 200, for example, the silicon photonic chip 400, the laser assembly 500, the substrate 302, and the groove, is one.

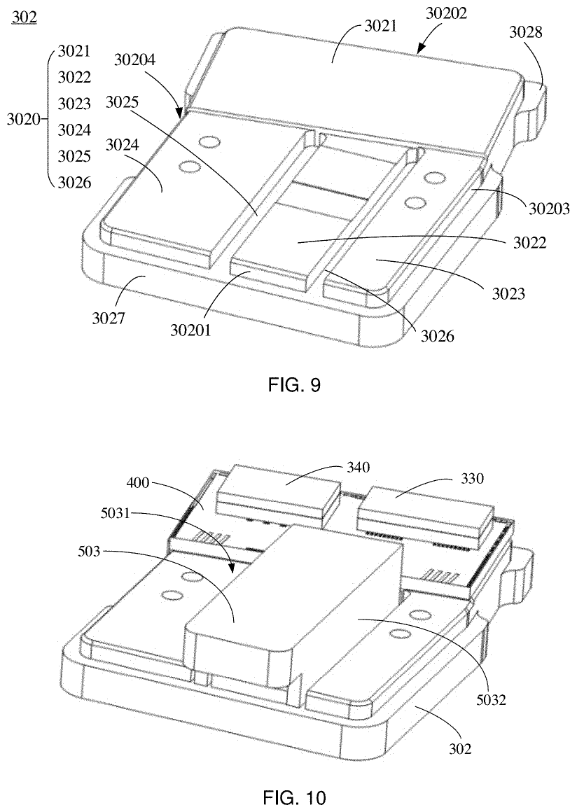

In some embodiments, as shown in FIG. 7, the groove is a though hole 303 penetrating the upper and lower surfaces of the circuit board 300, the substrate 302 is disposed in the through hole 303, and the silicon photonic chip 400 and the laser assembly 500 are disposed on a surface of the substrate 302. FIG. 8 is a structural diagram of a substrate in an optical module, in accordance with some embodiments, and FIG. 9 is a structural diagram of a substrate in an optical module from another angle, in accordance with some embodiments. As shown in FIGS. 8 and 9, the substrate 302 is an integrated structure. The substrate 302 includes a body 3020, a first support step 3027, and a second support step 3028, and the first support step 3027 and the second support step 3028 are disposed at two opposite ends of the body 3020. The body 3020 includes four clamping portions, which are a first clamping portion 3021, a second clamping portion 3022, a third clamping portion 3023 and a fourth clamping portion 3024, respectively. The second clamping portion 3022, the third clamping portion 3023 and the fourth clamping portion 3024 are arranged side by side, and the first clamping portion 3021 is disposed at ends of the second clamping portion 3022, the third clamping portion 3023 and the fourth clamping portion 3024 that are proximate to the connecting finger 301 of the circuit board 300.

The body 3020 further includes a first gap 3025 and a second gap 3026. The first gap 3025 is disposed between the second clamping portion 3022 and the fourth clamping portion 3024, and the second gap 3026 is disposed between the second clamping portion 3022 and the third clamping portion 3023. The first gap 3025 and the second gap 3026 are configured to fix the laser upper cover 503. The body 3020 has a first side surface 30201 and a second side surface 30202 that are disposed opposite each other, and a third side surface 30203 and a fourth side surface 30204 that are disposed opposite each other. The first support step 3027 is disposed around the first side surface 30201, and parts of the third side surface 30203 and the fourth side surface 30204. The second support step 3028 is disposed around the second side surface 30202, and parts of the third side surface 30203 and the fourth side surface 30204. The first support step 3027 and the second support step 3028 may be protruding structures.

The body 3020 is embedded in the through hole 303 of the circuit board 300, and the first support step 3027 and the second support step 3028 support the circuit board 300. A distance from an upper surface (a surface proximate to the cover plate 2011) of the body 3020 to an upper surface (a surface proximate to the cover plate 2011) of the first support step 3027 or the second support step 3028 is equal to a thickness of the circuit board 300. In addition, to enhance the reliability of a connection between the substrate 302 and the circuit board 300, an adhesive may be used to fix the first support step 3027 and the second support step 3028 of the substrate 302 to the circuit board 300. That is, the upper surface of the first support step 3027 and the upper surface of the second support step 3028 are fixed to a lower surface (a surface away from the cover plate 2011) of the circuit board 300 by an adhesive.

FIG. 10 is an assembly diagram of a substrate, a silicon photonic chip and a laser assembly in an optical module, in accordance with some embodiments, and FIG. 11 is an exploded view of a substrate, a silicon photonic chip and a laser assembly in an optical module, in accordance with some embodiments. As shown in FIGS. 6, 10 and 11, the silicon photonic chip 400 is disposed on a surface of the first clamping portion 3021, and the transimpedance amplifier 330 and the laser driver chip 340 are disposed on a surface of the silicon photonic chip 400 away from the first clamping portion 3021. The laser assembly 500 is disposed on a surface of the second clamping portion 3022, the first optical fiber ribbon connector 701 is disposed on a surface of the third clamping portion 3023, and the second optical fiber ribbon connector 702 is disposed on a surface of the fourth clamping portion 3024.

The laser upper cover 503 of the laser assembly 500 covers the second clamping portion 3022, and forms a sealed space with the second clamping portion 3022. The laser chip 510, the spacer 520, the collimating lens 530, the isolator 540, and the converging lens 550 are all disposed on the second clamping portion 3022 and are located in the sealed space formed by the laser upper cover 503 and the second clamping portion 3022, so that the above components are prevented from being contaminated or damaged.

The laser upper cover 503 includes a laser cover plate 5033, and a first side plate 5031 and a second side plate 5032 that are connected to the laser cover plate 5033 and disposed opposite each other. The first side plate 5031 is inserted into the first gap 3025 of the substrate 302, and the second side plate 5032 is inserted into the second gap 3026 of the substrate 302. An end of the laser cover plate 5033 away from the silicon photonic chip 400 extends beyond the first side plate 5031 and the second side plate 5032, and is bridged over the circuit board 300. That is, the circuit board supports the laser cover plate 5033. The laser upper cover 503 is configured to protect the various components of the laser assembly 500, such as the laser chip 510, the spacer 520, the collimating lens 530, the isolator 540, the converging lens 550, and the wiring region of the laser assembly 500.

The laser assembly 500 is mounted on the second clamping portion 3022. For example, the laser assembly 500 is connected to the circuit board 300 by a wire bonding process.

Since the circuit board 300 is disposed on the first support step 3027 and the second support step 3028 of the substrate 302 through the through hole 303, a surface of the substrate 302 facing away from the silicon photonic chip 400 and the laser assembly 500 is in contact with the shell (e.g., the lower shell 202) of the optical module 200. Therefore, the heat inside the optical module 200 may be transmitted to the shell of the optical module 200 through the substrate 302 and then conducted to the outside of the optical module 200, which avoids the accumulation of heat inside the optical module 200. Meanwhile, the various components of the laser assembly 500, such as the laser chip 510, the spacer 520, the collimating lens 530, the isolator 540 and the converging lens 550 are disposed on the substrate 302 and are wrapped by the laser upper cover 503, which saves an encapsulation space of the laser assembly 500 and facilitates the encapsulation of the laser assembly 500.

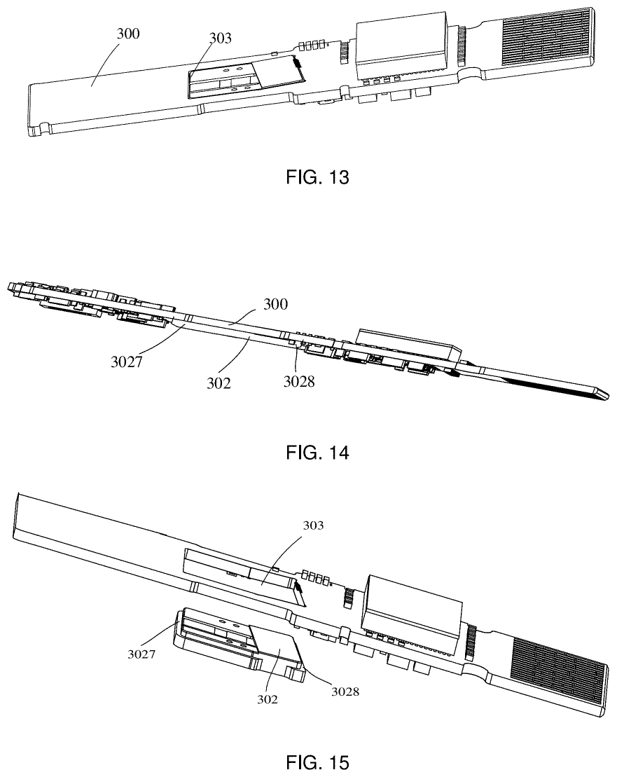

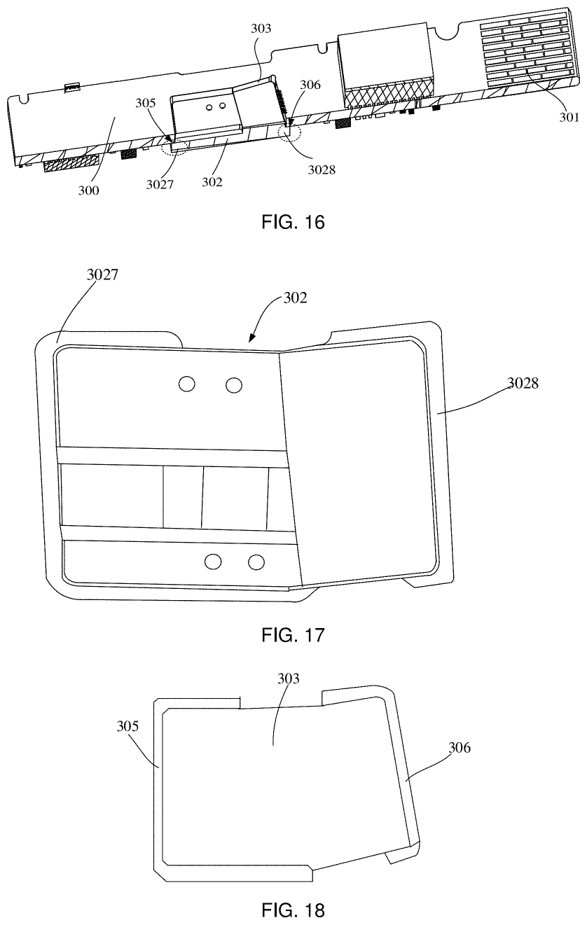

FIG. 13 is an assembly diagram of a substrate and a circuit board in an optical module, in accordance with some embodiments; FIG. 14 is an assembly diagram of a substrate and a circuit board in an optical module from another angle, in accordance with some embodiments; FIG. 15 is an exploded view of a substrate and a circuit board in an optical module, in accordance with some embodiments; and FIG. 16 is a cross-sectional view of a substrate and a circuit board that have been assembled in an optical module, in accordance with some embodiments.

As shown in FIGS. 13 to 16, the circuit board 300 further includes a first metal layer 305 and a second metal layer 306. The first metal layer 305 and the second metal layer 306 are disposed on the lower surface of the circuit board 300, and correspond to positions of the first support step 3027 and the second support step 3028, respectively. The first metal layer 305 and the second metal layer 306 are configured to be connected to the substrate 302 and a ground layer of the circuit board 300. The first metal layer 305 is connected to the ground layer of the circuit board 300, and the first metal layer 305 is connected to the first support step 3027 of the substrate 302. The second metal layer 306 is connected to the ground layer of the circuit board 300, and the second metal layer 306 is connected to the second support step 3028 of the substrate 302.

For example, the ground layer of the circuit board 300 is disposed inside the circuit board 300, and the first metal layer 3027 and the second metal layer 3028 are connected to the ground layer of the circuit board 300 through via holes.

In the optical module 200, the silicon photonic chip 400 is disposed on the substrate 302. In a case where the substrate 302 is made of a non-conductive material, such as aluminum nitride ceramic, the silicon photonic chip 400 is connected to the ground layer of the circuit board 300 through a connection wire, such as a gold wire, so that the silicon photonic chip 400 is grounded.

In a case where the substrate 302 is made of a conductive material, such as tungsten copper, the silicon photonic chip 400 is electrically connected to the first metal layer 306 and the second metal layer 307 through the substrate 302, and the first metal layer 306 and the second metal layer 307 are electrically connected to the ground layer of the circuit board 300. In this way, the silicon photonic chip 400 is grounded through the substrate 302, which avoids the parasitic inductance caused by a grounding connection of the silicon photonic chip 400 through the gold wire, and ensures the quality of signal transmission.

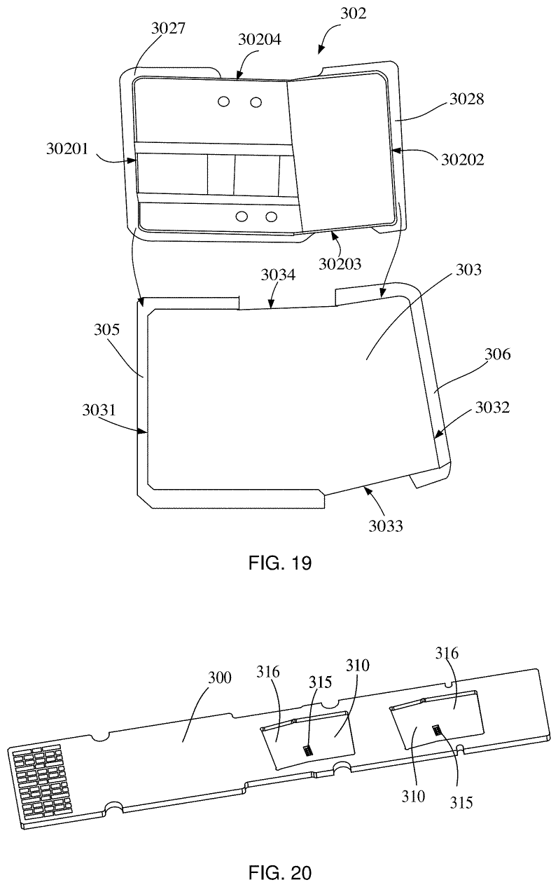

FIG. 17 is a top view of a substrate in an optical module, in accordance with some embodiments; FIG. 18 is a structural diagram of a metal layer laid on an outer periphery of a through hole of a circuit board in an optical module, in accordance with some embodiments; and FIG. 19 is a diagram showing a relative positional relationship between support steps of a substrate and metal layers laid on an outer periphery of a through hole in an optical module, in accordance with some embodiments. As shown in FIGS. 17 to 19, a shape of the first metal layer 305 of the circuit board 300 is the same as a shape of the first support step 3027 of the substrate 302, and a shape of the second metal layer 306 of the circuit board 300 is the same as a shape of the second support step 3028 of the substrate 302.

The through hole 303 has a first side 3031 and a second side 3032 that are disposed opposite each other, and a third side 3033 and a fourth side 3034 that are disposed opposite each other. For example, the first support step 3027 is disposed around the first side surface 30201, and parts of the third side surface 30203 and the fourth side surface 30204 of the body 3020 of the substrate 302, and the first metal layer 305 is disposed around the first side 3031, and parts of the third side 3033 and the fourth side 3034 of the through hole 303. The second support step 3028 is disposed around the second side surface 30202, and parts of the third side surface 30203 and the fourth side surface 30204 of the body 3020, and the second metal layer 306 is disposed around the second side 3032, and parts of the third side 3033 and the fourth side 3034 of the through hole 303.

In some embodiments of the present disclosure, the first support step 3027 and the first metal layer 305 are connected by conductive silver paste, and the second support step 3028 and the second metal layer 305 are connected by conductive silver paste.

FIG. 23 is an enlarged view showing a relative relationship between a signal pad and other structures in an optical module, in accordance with some embodiments, and FIG. 24 is a structural diagram of a laser assembly in an optical module, in accordance with some embodiments. As shown in FIGS. 20, 21, 22, 23, and 24, the groove is a blind hole 310 disposed in the upper surface (the surface proximate to the cover plate 2011) of the circuit board 300; the blind hole 310 does not penetrate the upper and lower surfaces of the circuit board 300, and a bottom surface of the blind hole 310 can be seen in a top view thereof. The substrate 302 is embedded in the blind hole 310, and the silicon photonic chip 400 and the laser assembly 500 are disposed on the surface of the substrate 302. For an optical module with a high transmission rate and a large number of electronic components, the provision of the blind hole 310 makes it possible for the electronic components to be arranged in a region on the lower surface of the circuit board 300 corresponding to the blind hole 310, and for the wiring of the inner layers of the circuit board to be arranged in a region between the bottom of the blind hole 310 and the lower surface of the circuit board 300.

In some embodiments of the present disclosure, a surface of the silicon photonic chip 400 proximate to the cover plate 2011 is flush with a surface of the circuit board 300 proximate to the cover plate 2011, and a surface of the laser assembly 500 proximate to the cover plate 2011 is flush with the surface of the circuit board 300 proximate to the cover plate 2011. With this arrangement, a length of connection wires of the silicon photonic chip 400 and the laser assembly 500 may be shortened.

The blind hole 310 includes a metal layer 316 disposed on a bottom surface thereof, and the metal layer 316 may be, for example, a copper layer or an aluminum layer. A description will be given below by taking an example where the metal layer 316 is a copper layer.

The copper layer 316 is configured to transfer heat conducted from the silicon photonic chip 400 and the laser assembly 500 to the substrate 302 to the shell of the optical module 200, so as to facilitate the heat dissipation of the optical module 200 and avoid heat accumulation inside the optical module 200. The blind hole 310 further includes a signal pad 315 disposed on the bottom surface thereof, and the signal pad 315 is configured to be connected to the silicon photonic chip 400 through a connection wire.

The circuit board 300 includes a ground layer and a signal layer, the copper layer 316 is connected to the ground layer through a via hole, and the signal pad 315 is connected to the signal layer through a via hole.

As shown in FIGS. 21, 22, and 23, the substrate 302 includes four thermal pads arranged separately, which are a first thermal pad 3041, a second thermal pad 3042, a third thermal pad 3043, and a fourth thermal pad 3044.

The second thermal pad 3042, the third thermal pad 3043, and the fourth thermal pad 3044 are arranged side by side, and the first thermal pad 3041 is disposed at ends of the second thermal pad 3042, the third thermal pad 3043, and the fourth thermal pad 3044 that are proximate to the connecting finger 301 of the circuit board 300. The silicon photonic chip 400 is disposed on the first thermal pad 3041, the laser assembly 500 is disposed on the second thermal pad 3042, the first optical fiber ribbon connector 701 is disposed on the third thermal pad 3043, and the second optical fiber ribbon connector 702 is disposed on the fourth thermal pad 3044.

The first thermal pad 3041, the second thermal pad 3042, the third thermal pad 3043, and the fourth thermal pad 3044 are all embedded in the blind hole 310 and located on the copper layer 316. The first thermal pad 3041 is configured to conduct heat generated by the silicon photonic chip 400 to the copper layer 316 of the blind hole 310; the second thermal pad 3042 is configured to conduct heat generated by the laser assembly 500 to the copper layer 316 of the blind hole 310; the third thermal pad 3043 is configured to conduct heat on the first internal optical fiber ribbon 601 to the copper layer 316 of the blind hole 310; and the fourth thermal pad 3044 is configured to conduct heat on the second internal optical fiber ribbon 602 to the copper layer 316 of the blind hole 310. The first thermal pad 3041, the second thermal pad 3042, the third thermal pad 3043, and the fourth thermal pad 3044 may be fixed to the copper layer 316 of the blind hole 310 by a thermally conductive adhesive.

In some embodiments of the present disclosure, thermal expansion coefficients of the first thermal pad 3021, the second thermal pad 3022, the third thermal pad 3023, and the fourth thermal pad 3024 are matched with the thermal expansion coefficients of the silicon photonic chip 400, the laser assembly 500, the first internal optical fiber ribbon 601, and the second internal optical fiber ribbon 602, respectively, so as to ensure the stability of the optical path at different temperatures.

The silicon photonic chip 400 is disposed on the substrate 302, and in a case where the thermal pads of the substrate 302 are made of a non-conductive material, such as aluminum nitride ceramic, the silicon photonic chip 400 is electrically connected to the ground layer of the circuit board 300 through a connection wire, such as a gold wire.

In a case where the thermal pads of the substrate 302 are made of a conductive material, such as tungsten copper, the silicon photonic chip 400 may be directly electrically connected to the copper layer 316 of the blind hole 310 through the substrate 302, and the copper layer 316 is electrically connected to the ground layer of the circuit board 300 through a via hole. In this way, the silicon photonic chip 400 is grounded through the substrate 302, which avoids the parasitic inductance caused by a grounding connection of the silicon photonic chip 400 through the gold wire and ensures the quality of signal transmission.

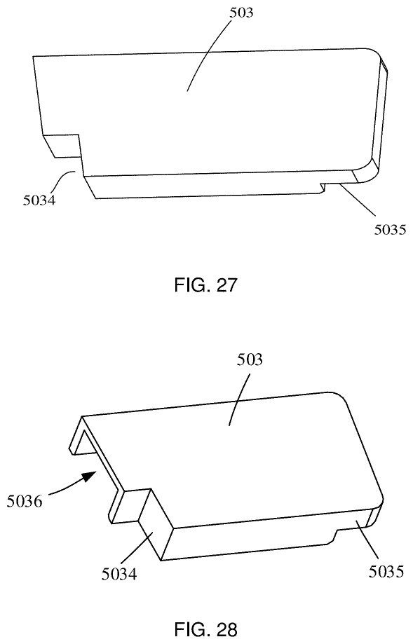

FIG. 25 is a structural diagram of a circuit board, a silicon photonic chip, and a laser assembly in an optical module, in accordance with some embodiments; FIG. 26 is a diagram showing a relative positional relationship between a laser upper cover and a circuit board in an optical module, in accordance with some embodiments; FIG. 27 is a structural diagram of a laser upper cover in an optical module, in accordance with some embodiments; and FIG. 28 is a structural diagram of a laser upper cover in an optical module from another angle, in accordance with some embodiments. As shown in FIGS. 25 to 28, the laser upper cover 503 covers the second thermal pad 3042 and is in contact with the copper layer 316. The laser upper cover 503 and the second thermal pad 3042 form a sealed space, and the laser chip 510, the spacer 520, the collimating lens 530, the isolator 540, and the converging lens 550 are all disposed on the second thermal pad 3042 and are located in the sealed space formed by the laser upper cover 503 and the second thermal pad 3042, so that the above components are prevented from being contaminated or damaged.

The laser upper cover 503 includes a notch 5034, a protruding end 5035, and a cavity 5036. The notch 5034 is used to avoid the signal pad 315 of the blind hole 310 (as shown in FIG. 23), just so that the signal pad 315 is not covered by the laser upper cover 503, which facilitates a connection between the silicon photonic chip 400 and the circuit board 300. The protruding end 5035 is bridged over the circuit board 300; that is, the circuit board 300 supports the protruding end 5035 and, in turn, supports the laser upper cover 503. The cavity 5036 is used to cover the components such as the laser chip 510, the spacer 520, the collimating lens 530, the isolator 540, and the converging lens 550 on the second thermal pad 3042 and the wiring region of the laser assembly 500.

In this case, the heat generated by the silicon photonic chip 400, the laser assembly 500, the first internal optical fiber ribbon 601, and the second internal optical fiber ribbon 602 is transferred to the copper layer 316 of the blind hole 310 through the thermal pads, respectively. A portion of the heat is transferred to the lower shell 202 of the optical module 200 through the circuit board 300, and is dissipated through the lower shell 202; and another portion of the heat is transferred to the upper shell 201 of the optical module 200 through the laser upper cover 503, and is dissipated through the upper shell 201.

Therefore, the heat inside the optical module 200 may be transmitted to the shell of the optical module 200 through the laser upper cover 503 and the circuit board 300, and then the heat is conducted to the outside of the optical module 200, which avoids heat accumulation inside the optical module 200.

In some embodiments of the present disclosure, the laser upper cover 503 may be made of a metal material with high thermal conductivity, including tungsten copper and molybdenum copper. To achieve a better heat dissipation effect, a contact area between the laser upper cover 503 and the copper layer 316 may be made larger, because the larger the contact area, the better the heat dissipation.

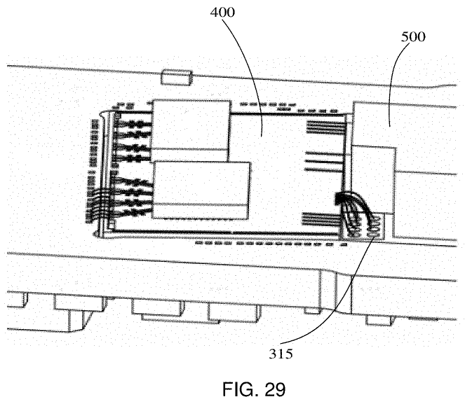

FIG. 29 is a connection diagram of a silicon photonic chip and a circuit board in an optical module, in accordance with some embodiments. As shown in FIG. 29, an end of the silicon photonic chip 400 away from the laser upper cover 503 is connected to the circuit board 300 through a connection wire, so as to achieve high-speed signal transmission between the circuit board 300 and the silicon photonic chip 400; and an end of the silicon photonic chip 400 proximate to the laser upper cover 503 is connected to the signal pad 315 of the blind hole 310 through a connection wire, so as to achieve low-speed signal transmission between the circuit board 300 and the silicon photonic chip 400. In this way, a signal connection between the silicon photonic chip 400 and the circuit board 300 is achieved.

In some embodiments of the present disclosure, the silicon photonic chip 400 is disposed on the first thermal pad 3041 instead of the surface of the circuit board 300. In this way, it may be possible to shorten a length of the gold wire used for high-frequency signal transmission between the silicon photonic chip 400 and the circuit board 300, and in turn optimize the transmission performance of high frequency signals.

In some embodiments of the present disclosure, the transimpedance amplifier 330 and the laser driver chip 340 are flip-chip soldered on the silicon photonic chip 400; that is, the surfaces of the transimpedance amplifier 330 and the laser driver chip 340 on which the electronic components are disposed face the silicon photonic chip 400. The surfaces of the transimpedance amplifier 330 and the laser driver chip 340 on which the electronic components are disposed are defined as front surfaces of the transimpedance amplifier 330 and the laser driver chip 340, and the surfaces opposite to the front surfaces are defined as back surfaces; therefore, the back surfaces of the transimpedance amplifier 330 and the laser driver chip 340 are immediately adjacent to the upper shell 201 of the optical module 200. In order to achieve the heat dissipation of the transimpedance amplifier 330 and the laser driver chip 340, a heat conduction column may be used to transfer heat between the transimpedance amplifier 330 and the upper shell 201 of the optical module 200, and a thermally conductive adhesive may also be filled in a gap between the transimpedance amplifier 330 and the upper shell 201 of the optical module 200 to transfer heat; as for the laser driver chip 340, the heat conduction column or thermally conductive adhesive may also be used to transfer heat.

Those skilled in the art will understand that the scope of disclosure of the present disclosure is not limited to the embodiments described above, and that modifications and substitutions of certain elements of the embodiments may be made without departing from the spirit of the present disclosure. The scope of the present disclosure is limited by the appended claims.

What is claimed is:

1. An optical module, comprising:
a circuit board including a through hole disposed in a surface thereof;
a substrate disposed in the through hole;
a laser assembly disposed on the substrate; and
a silicon photonic chip disposed on the substrate and optically connected to the laser assembly, the silicon photonic chip being electrically connected to the circuit board through the substrate so as to ground the silicon photonic chip;
wherein the substrate includes:
a body disposed in the through hole, the laser assembly and the silicon photonic chip being disposed on the body;
a first support step disposed at an end of the body and configured to support the circuit board; and
a second support step disposed at another end of the body and configured to support the circuit board; and
wherein the circuit board includes:
a first metal layer disposed on a surface of the circuit board proximate to the first support step and corresponding to a position of the first support step, the first metal layer being electrically connected to the first support step; and
a second metal layer disposed on a surface of the circuit board proximate to the second support step and corresponding to a position of the second support step, and the second metal layer being electrically connected to the second support step.

2. The optical module according to claim 1, wherein the first metal layer is electrically connected to the first support step through conductive silver paste, and the second metal layer is electrically connected to the second support step through conductive silver paste.

3. The optical module according to claim 1, wherein the first support step and the second support step are protruding structures.

4. The optical module according to claim 1, wherein a shape of the first support step is the same as a shape of the first metal layer, and a shape of the second support step is the same as a shape of the second metal layer.

5. The optical module according to claim 4, wherein the body includes a first side surface and a second side surface disposed opposite each other, and a third side surface and a fourth side surface disposed opposite each other; and
the first support step is disposed around the first side surface and parts of the third side surface and the fourth side surface, and the second support step is disposed around the second side surface and parts of the third side surface and the fourth side surface.

6. The optical module according to claim 5, wherein the through hole includes a first side and a second side disposed opposite each other, and a third side and a fourth side disposed opposite each other; and
the first metal layer is disposed around the first side, and parts of the third side and the fourth side, and the second metal layer is disposed around the second side and parts of the third side and the fourth side.

7. The optical module according to claim 1, wherein a distance between a surface of the body proximate to the silicon photonic chip and a surface of the first support step proximate to the silicon photonic chip is equal to a thickness of the circuit board; and
a distance between the surface of the body proximate to the silicon photonic chip and a surface of the second support step proximate to the silicon photonic chip is equal to the thickness of the circuit board.

8. The optical module according to claim 1, wherein the body includes:
a first clamping portion, the silicon photonic chip being disposed on the first clamping portion; and
a second clamping portion, the laser assembly being disposed on the second clamping portion.

9. The optical module according to claim 8, wherein the laser assembly includes:
a laser upper cover covering the second clamping portion; and
a laser chip disposed on the second clamping portion and located in a cavity formed by the laser upper cover and the second clamping portion.

10. An optical module, comprising:
a circuit board including a blind hole disposed in a surface thereof, the blind hole including a metal layer disposed on a bottom surface thereof;
a substrate disposed in the blind hole and located on the metal layer, the substrate being electrically connected to the circuit board through the metal layer;
a laser assembly disposed on the substrate; and
a silicon photonic chip disposed on the substrate and optically connected to the laser assembly, the silicon photonic chip being electrically connected to the circuit board through the substrate so as to ground the silicon photonic chip.

11. The optical module according to claim 10, wherein a surface of the silicon photonic chip away from the substrate is flush with the surface of the circuit board in which the blind hole is disposed; and
a surface of the laser assembly away from the substrate is flush with the surface of the circuit board in which the blind hole is disposed.

12. The optical module according to claim 10, wherein the blind hole further includes a signal pad disposed on a bottom surface thereof; and
the silicon photonic chip is electrically connected to the signal pad through a connection wire, so as to realize signal transmission between the silicon photonic chip and the circuit board.

13. The optical module according to claim 12, wherein the substrate includes:
a first thermal pad, the silicon photonic chip being disposed on the first thermal pad; and
a second thermal pad, the laser assembly being disposed on the second thermal pad.

14. The optical module according to claim 13, wherein the laser assembly includes:
a laser upper cover covering the second thermal pad and in contact with the metal layer; and
a laser chip disposed on the second thermal pad and located in a cavity formed by the laser upper cover and the second thermal pad.

15. The optical module according to claim 14, wherein the laser upper cover includes:
a notch configured to avoid the signal pad; and
a protruding end bridged over the circuit board.

16. The optical module according to claim 1, further comprising:
an optical fiber interface;
a first internal optical fiber ribbon, an end of the first internal optical fiber ribbon being connected to the silicon photonic chip, another end of the first internal optical fiber ribbon being connected to the optical fiber interface, and the first internal optical fiber ribbon being configured to transmit an optical signal to an outside of the optical module; and
a second internal optical fiber ribbon, an end of the second internal optical fiber ribbon being connected to the silicon photonic chip, another end of the second internal optical fiber ribbon being connected to the optical fiber interface, and the second internal optical fiber ribbon being configured to receive an optical signal from the outside of the optical module.

17. The optical module according to claim 16, further comprising:
a first optical fiber ribbon connector disposed on the substrate and configured to clamp the end of the first internal optical fiber ribbon connected to the silicon photonic chip; and
a second optical fiber ribbon connector disposed on the substrate and configured to clamp the end of the second internal optical fiber ribbon connected to the silicon photonic chip.
